(19) United States
(12) Patent Application Publication
(10) Pub. No.: US 2002/0150071 A1
(43) Pub. Date: Oct. 17, 2002

(54) Method and arrangement to determine a clock timing error in a multi-carrier transmission system

(75) Inventors: Thierry Pollet M. Pollet, Mechelen (BE); Luc Van Den Dorpe, Louvain-La-Neuve (BE); Laurent Cuvelier, Gentinnes (BE); Miguel Peeters, Brussels (BE)

Correspondence Address: SUGHRUE MION, PLLC, 2100 Pennsylvania Avenue, NW, Washington, DC, 20037-3213, US

(73) Assignee: ALCATEL

(21) Appl. No.: 10/035,302

(22) Filed: Jan. 4, 2002

(30) Foreign Application Priority Data
Jan. 5, 2001 (EP) 01400024.4

(51) Int. Cl. H04B 7/216

(52) U.S. Cl. 370/342; 370/441

(57) ABSTRACT

The invention relates to a reception arrangement for receiving multicarrier symbols, each multicarrier symbol (S₁, S₂, S₃) comprising a plurality of single carrier symbols, each symbol modulating a respective carrier frequency (f₁, f₂, f₃). The single carrier symbols are transmitted simultaneously. The arrangement comprises means for detecting phase error of each single carrier and means for correcting the phase of a sampling clock (52) in view of the estimated error.

The means for estimating phase error comprise means (58₁ . . . 58_{N}, 24, 40) for determining a parameter êi for a carrier fi according to the following formula:

$${\hat{e}}_{i} = E ⌊ {r}_{k - 1}^{i} {a}_{k}^{i *} - {r}_{k}^{i} {a}_{k - 1}^{i *} ⌋ \qquad ( 3 )$$

wherein rₖⁱ the detected signal for the single carrier at a time t, aₖⁱ is the corresponding symbol at the same time t, aₖ₋₁ⁱ and rₖ₋₁ⁱ correspond, respectively, to aₖⁱ and rₖⁱ at time t−NT, NT being the duration of transmission of a multicarrier symbol, and E[ ] means an average value on several successive symbols.

The invention relates to a method and an arrangement to determine a clock timing error in a multicarrier transmission system. In a multicarrier transmission system, such as a discrete multitone (DMT) transmission system, an information symbol is transmitted simultaneously on several modulated carriers.

Accurate timing information must be known to the receiver in order to produce reliable estimates of the transmitted information sequence. A synchronizer determines which samples of the received signal are to be presented to a decision device. Usually, the timing information is not a priori known to the receiver and can be extracted from the received signal. For transmission over an ideal channel, the received signal is a delayed version of the transmitted signal (due to the transmission delay introduced by the transmission channel). This delay, together with the difference in symbol clock (phase) between transmitter and receiver is estimated by a synchronizer unit.

When signals are transmitted over a dispersive channel, equalization may be performed by the receiver essentially with the purpose to reverse the effect of the channel.

In order to estimate this timing error in a multicarrier transmission system, a common method applied to DMT uses a data-aided algorithm wherein the sampling clock is first roughly synchronized and, at least for one tone or carrier, the position, in the complex plane, of the detected symbol is compared with the position in this plane of the signal at the input of the decision device, and this comparison provides a phase error which is used for correction.

This estimation may be performed either on one single pilot carrier or, in order to reduce the noise of the estimation and the tracking range, on a combination of pilot carriers.

The method and the arrangement according to the invention provide an alternative which can be used for DMT transmission where the cyclic prefix is absent or for other types of multi carrier transmission (e.g. multi-carrier systems based on filter banks).

The arrangement according to the invention is characterized in that for timing error correction on the receiving side of a multicarrier data, it comprises, for at least one, and preferably, a plurality of carriers, a Mueller and Muller timing error estimator.

Such Mueller and Muller timing error estimation is already known in the art, for instance in single carrier transmission synchronizers wherein the cascade of the baseband equivalent of the impulse response of the transmit shaping filter and the receiver filter impulse response is a Nyquist pulse.

According to this method, the filtered version of the timing error estimate, e, which is used for timing correction has the following value:

e=E[rₖ₋₁aₖ^{*}−rₖaₖ₋₁^{*}] (1)

In this formula:

rₖ is the measured complex value of the signal at the input of a decision device at a given time tₖ of a sampling clock which is roughly synchronized,

aₖ is the complex value of a symbol to be estimated from rₖ,

rₖ₋₁ and aₖ₋₁ correspond to, respectively, rₖ and aₖ but at a time tₖ−NT, where NT is the symbol period,

aₖ* and aₖ₋₁* are the complex conjugate values of, respectively, aₖ and aₖ₋₁, and,

E[ ] represents the average of the value between brackets on a given plurality of successive values of k, i.e. at times t−nNT, . . . , t, t+NT, t+2NT, . . . , t+nNT.

This method provides an error signal which varies in function of the symbol timing error according to a S curve which is particularly suitable for correction. The particular shape of the S curve depends on the shape of the transmitted pulse and on the receiver filters.

In multicarrier transmission e must be multiplied with a (a=−1, a=1) such that when the product ae is used in a feedback synchroniser system, a stable timing locked loop is obtained. The value a depends on the carrier-index.

In a preferred embodiment, the timing error is estimated by the calculation of the parameter êᵢ for all the carriers, the multicarrier timing error signal being a weighted average of the values of said êᵢ parameters, the weighting coefficient of each êᵢ parameter depending on the carrier frequency. This weighting coefficient depends for instance of the quality of transmission of the corresponding single carrier channel and/or of the signal to noise ratio of the corresponding transmission channel.

If, for example, the method is applied to the transmission of a DMT signal, with N modulated carriers, the signal s(t) at the output of the transmitter is given by

$$s ( t ) = {\sum }_{k = - ∞}^{+ ∞} {\sum }_{m = 0}^{2 N - 1} {\sum }_{n = 0}^{2 N - 1} {a}_{m}^{k} \cdot p ( t - \frac{n \cdot T}{2} - k \cdot 2 N \cdot \frac{T}{2} ) \cdot {ⅇ}^{j \cdot \frac{2 π}{2 N} \cdot m \cdot n}$$

wherein:

N is the number of carriers in the DMT signal, i.e. 256 in an ADSL system;

aₖ^{m} is the symbol modulating the mth carrier in the kth DMT symbol period with a variance equal to 1;

p(t) is the transmitted pulse for each sample, with p(t)=1 for 0≦t≦T/2, and p(t)=0 elsewhere;

t is the time;

$$\frac{2}{T}$$

is the sampling rate;

n is a sample index;

m is a carrier index;

k is a DMT symbol index;

j is the square root of −1;

π=3.1415;

∞ is the usual symbol representing infinity.

For a timing error (τₑ ), the signal at the input of the decision device for carrier m at t=τₑ (not taking into account the contributions of signals transmitted over carriers other than m) is:

$${r}_{k} ( t ) = {\sum }_{k = - ∞}^{+ ∞} {\sum }_{n = - 2 N}^{2 N - 1} {a}_{m}^{k} \cdot ( 2 N - \vert n \vert ) g ( {τ}_{e} - \frac{n \cdot T}{2} - k \cdot 2 N \cdot \frac{T}{2} ) \cdot {ⅇ}^{j \cdot \frac{2 π}{2 N} \cdot m \cdot n}$$

where

$$g ( t ) = \{ \begin{matrix}T / 2 - \vert t \vert & \vert t \vert \leq T / 2 \\ 0 & elsewhere\end{matrix}$$

The Mueller and Müiller timing error estimation applied to carrier m provides a term proportional to

$${τ}_{e} {ⅇ}^{j \frac{2 π}{2 N} m .}$$

The imaginary part of this term can be used as estimate of the timing error τₑ.

In a preferred embodiment, each error signal eᵢ is weighted according to the quality of transmission of the corresponding channel. In fact, each carrier is considered as transmitted on a channel which is distinct from the channel transmitting another carrier, and the quality of transmission may differ from one channel to the other. In that case, greater weights are given to transmissions having the best qualities and smaller weights are given to transmissions having the lowest qualities. In an embodiment, the weight given to each carrier channel is the signal to noise ratio (SNR).

In brief the invention provides a reception arrangement for receiving multicarrier symbols, each multicarrier symbol (S₁, S₂, S₃) comprising a plurality of single carrier symbols, each single carrier symbol modulating a respective carrier frequency (F₁, F₂, F₃), these single carrier symbols being transmitted simultaneously, the reception arrangement comprising means for detecting the time, or phase error, of at least one single carrier and means for correcting the phase of a sampling clock in view of the estimated timing error, wherein the means for estimating the timing or phase error comprise, at least for one carrier, means (58ᵢ . . . 58_{N}, 24, 40) for determining a parameter êᵢ for a carrier fᵢ, or a quantity proportional to the parameter êᵢ, according to the following formula:

$${\hat{e}}_{i} = E ⌊ {r}_{k - 1}^{i} {a}_{k}^{i *} - {r}_{k}^{i} {a}_{k - 1}^{i *} ⌋ \qquad ( 3 )$$

wherein rₖⁱ is the detected signal for the single carrier at a time t, aₖⁱ is the corresponding single carrier symbol at the same time t, aₖ₋₁ⁱ and rₖ₋₁ⁱ correspond, respectively, to aₖⁱ and rₖⁱ at time t−NT, NT being the duration of transmission of a multicarrier symbol, and E[ ] means an average value on several successive symbols.

Other features and advantages of the invention will appear with the description of certain of its embodiments, this description being made with reference to the herein happened drawings wherein:

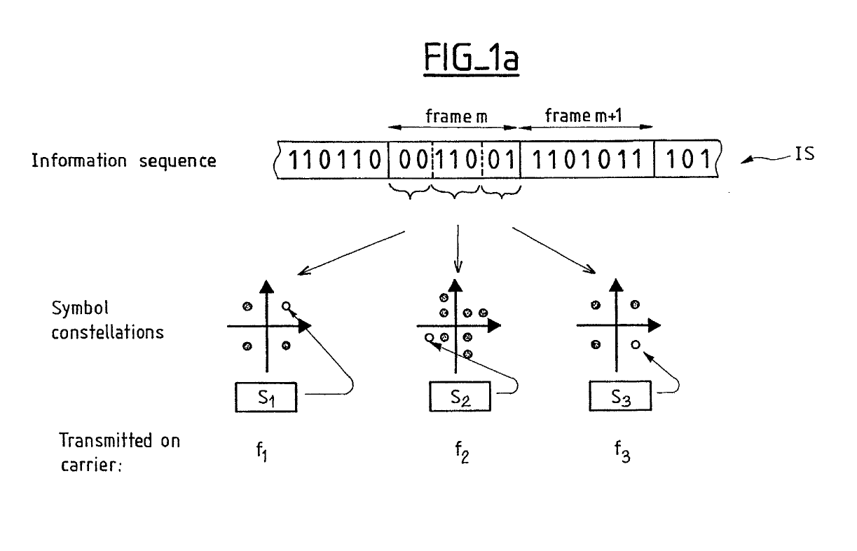

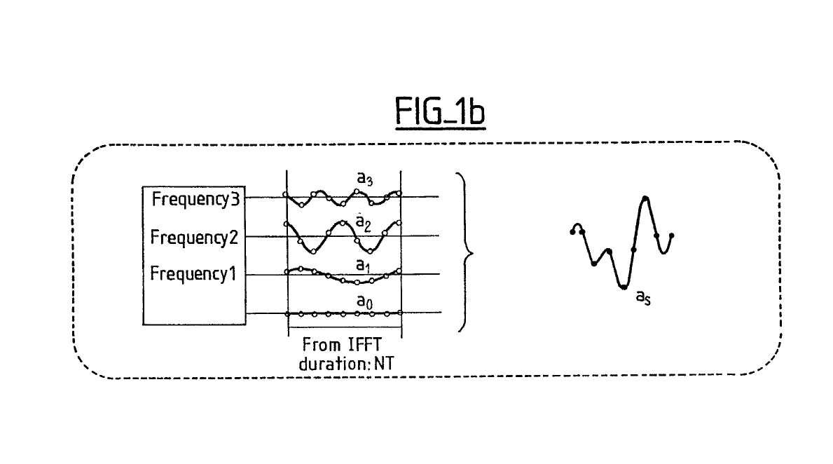

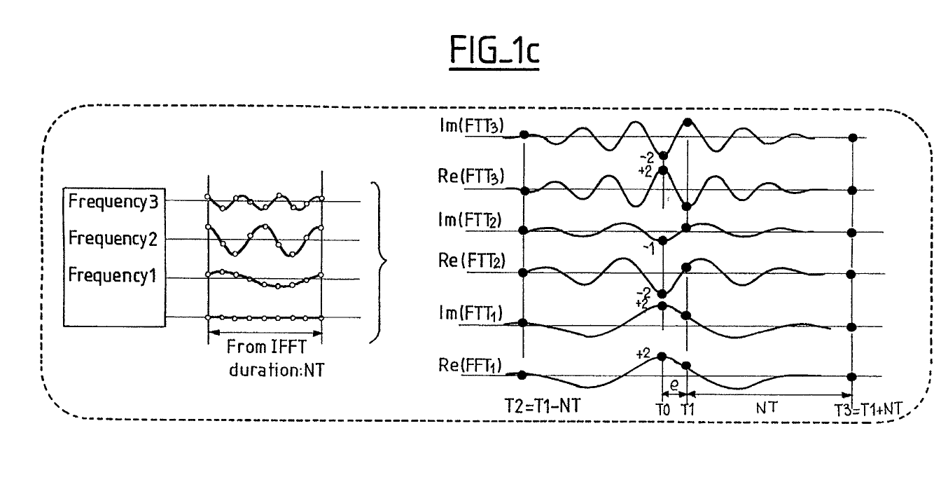

FIGS. 1a, 1b, 1c are diagrams illustrating schematically the principle of discrete multitone transmission,

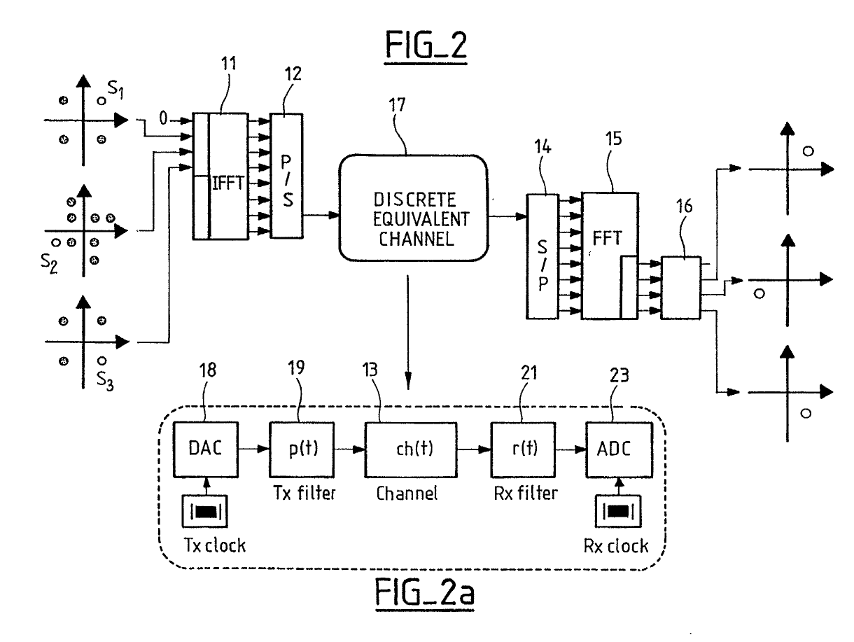

FIG. 2 shows a multicarrier modulator, a transmission channel and a multicarrier demodulator,

FIG. 2a shows with more details a part of the arrangement of FIG. 2,

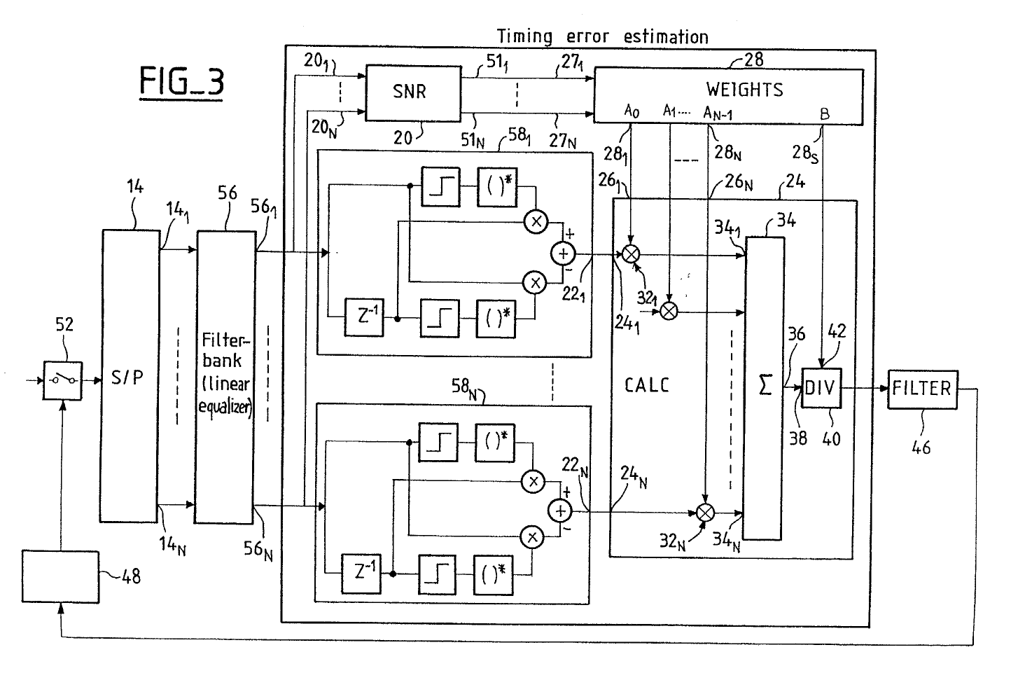

FIG. 3 illustrates a synchronizer for multicarrier transmission according to the invention, and

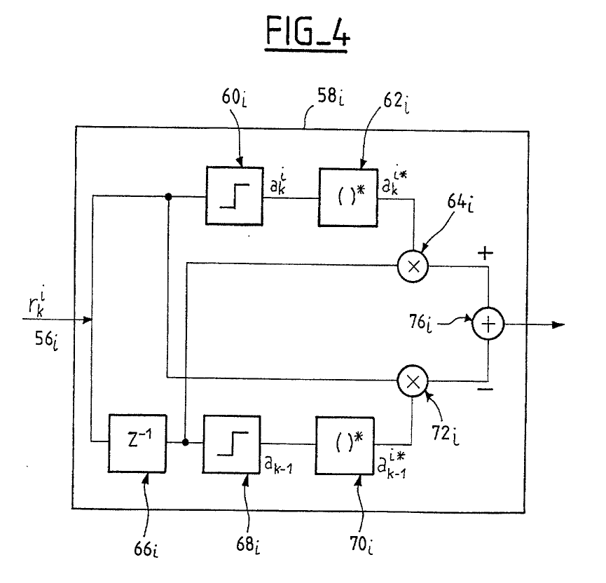

FIG. 4 shows an element of the synchroniser shown on FIG. 3.

The principle of multicarrier transmission will be explained with reference to FIGS. 1a, 1b, 1c and 2.

In FIG. 1a, an information sequence is having several binary information bits is represented. For the m-th frame, the two most significant bits form a symbol S₁ which is transmitted with carrier frequency f₁, the three following bits form a symbol S₂ which is transmitted with carrier frequency f₂, and the two least significant bits form a symbol S₃ which is transmitted with carrier frequency f₃. On FIG. 1a, the symbols S₁, S₂ and S₃ are represented with the usual diagrams in the complex plane, these symbols being represented by circles. The black dots in the complex plane represent the other possible values to be transmitted. In other words, the complete constellation of values which it is possible to transmit are represented, i.e. 4 points for 2 bits and 8 points for 3 bits.

The symbols S₁, S₂ and S₃ modulate the corresponding carrier in amplitude and/or in phase.

FIG. 2 represents a modulator, a demodulator and a transmission channel. More precisely, FIG. 2 shows that the modulator comprises an IFFT module 11, i.e. a module providing the inverse fast Fourier transform of the carriers f₁, f₂, f₃ modulated by the symbols S₁, S₂ and S₃. The parallel outputs of IFFT module 11 are provided to inputs of a parallel/serial converter 12. The signals are transmitted in series through a discrete equivalent channel 17 (comprising the actual channel 13) to a receiving part comprising a demodulator including a serial/parallel converter 14, a FFT (fast Fourier transform) module 15 receiving the parallel outputs from the converter 14, and providing signals to a frequency equaliser module 16 which presents outputs on which appear the demodulated symbols S₁, S₂ and S₃.

The discrete equivalent channel 17 is represented on FIG. 2a. It comprises, in addition to the channel 13 itself, on the transmission side, a digital to analog converter 18, a transmission filter 19, corresponding to the impulse response of the transmitter filter, and on the receiving side, a filter 21 corresponding to the impulse response of the receiver filter, and an analog to digital converter 23.

As illustrated by FIG. 1b, the three symbols S₁, S₂, S₃ are converted in continuous-time signals that are transmitted simultaneously during a time NT. The starting points of transmission of symbols S₁, S₂, S₃ are the same and the end points of transmission of symbols S₁, S₂ and S₃ appear also at the same time instant.

The four analogs signals a₀, a₁, a₂ and a₃ (a₁, a₂ and a₃ corresponding to carrier frequencies f₁, f₂ and f₃) provided by the IFFT module, which are transmitted simultaneously, appear as a signal a_{S} on FIG. 1b.

FIG. 1c shows the variations with time of the (useful) signals at the outputs of the FFT module, assuming an ideal channel. More precisely, for the signal at the i-th FFT output (i=1,2,3), only the complex valued contribution of the i-th carrier is shown, the contribution of the intercarrier interference to the signal being not shown. Re (FFTᵢ) means the real part of complex signal (FFTᵢ) and Im (FFTᵢ) means the imaginary part of complex signal (FFTᵢ).

T0 is the optimal sampling instant at the receiver. As shown, at time T0, Re (FFT₁) has a value +2 and Im (FFT₁) has also a value +2. These values correspond to symbol S₁. At this time T0, Re (FFT₂) has the value −2 and Im (FFT₂) has the value −1 which correspond to symbol S₂ and Re (FFT₃) has the value +2 and Im (FFT₃) has the value −2 which correspond to symbol S₃.

T1 is the timing instant at the receiver when a timing error e=T1−T0 occurs. The synchronizer makes use of the FFT signals at time instants T2=T1−NT and T3−T1+NT to extract the estimated timing error.

The invention is based on the use of a Mueller and Müller synchroniser, at least for one of the tones or carriers.

In the preferred embodiment which is represented on FIG. 3, use is made of a Mueller and Müller error estimation for each carrier.

As shown on FIG. 3, the multicarrier, or discrete multitone, signal which is received is sampled by an analog to digital converter 52 and applied to the input of the series/parallel converter 14 which has a number of outputs 14₁, 14₂, . . . 14_{N} equal to the number of tones of the multicarrier signal. These parallel signals are applied to a filter bank 56 which realizes a linear equalization of the received single tones. Each single tone at the output 56₁, . . . , 56_{N} of the filter bank 56 is applied to the input of a corresponding Mueller and Muller module 58ᵢ and to the input 20ᵢ of a signal to noise ratio (SNR) estimator 20.

Each module 58ᵢ, which will be described later in more details, has an output 22ᵢ which is connected to a corresponding input 24ᵢ of a calculation module 24.

This calculation module 24 has parallel inputs 26₁, . . . , 26_{N} which are connected to corresponding outputs 28₁, . . . , 28_{N} of a module 28 assigning weights to the values provided on the outputs of modules 58ᵢ.

These weights provided by module 28 depend on the signal to noise ratio on the corresponding channel.

More precisely, the block 20 which determines the signal to noise ratio of each channel has (in the represented example) outputs 51ᵢ which are connected to corresponding inputs 27ᵢ of module 28 and this signal to noise ratio of each channel is provided on the corresponding output 28₁, . . . , 28_{N} multiplied with a weight which depends on the carrier.

For each carrier, the calculation module 24 has a multiplier 32ᵢ which multiplies the signal provided at the output 22ᵢ of module 58ᵢ by the weighting coefficient provided at the corresponding output 28ᵢ of the weighting module 28.

The output of the multiplier 32ᵢ is applied to an input 34ᵢ of an adder 34. The adder 34 has an output 36 which is connected to the numerator input 38 of a divider 40 having a denominator input 42 connected to an output 28_{S} of the weighting module 28.

The signal provided on input 42 is the square root of the sum of the square values of the weighting coefficients A₁, . . . , A_{N} provided on outputs 28₁, . . . , 28_{N}.

The normalized signal provided on the output of divider 40 is applied to the input of an averaging filter 46 and the output of this averaging filter is the signal which is used for the correction of a timing unit or sampling clock 48 which is used for the analog to digital conversion.

Each module 58i performs the following calculation:

eᵢrₖ₋₁ⁱaₖ^{i*}−rₖⁱaₖ₋₁^{i*} (2)

In this formula, aₖⁱ is the single tone symbol corresponding to carrier i at time t, rₖⁱ is the symbol measured at same time t and which differs from the symbol aₖⁱ because of the timing error. aₖ₋₁ⁱ and rₖ₋₁ⁱ represent, respectively, the actual symbol and the measured symbol at time t−NT.

In order to obtain this value eᵢ, each module 58ᵢ (FIG. 4) receives on its input the signal rₖⁱ and has a first branch comprising a decision circuit 60ᵢ which determines aₖⁱ in view of rₖⁱ, this decision module being followed by a complex conjugate circuit 62ᵢ which provides aₖ^{i*}.

The output aₖ^{i*} of circuit 62ᵢ is provided to the first input of a multiplier 64ᵢ having a second input connected to the output of a delay circuit 66ᵢ of duration NT receiving on its input the signal rₖⁱ and providing, therefore, on its output the signal rₖ₋₁ⁱ (due to the delay NT). This delay circuit 66ᵢ is followed also by another decision circuit 68ᵢ providing on its output the symbol aₖ₋₁ⁱ.

A circuit 70ᵢ transforms the value aₖ₋₁ⁱ into its complex conjugate value and the output of this circuit 70ᵢ is connected to the first input of a multiplier 72ᵢ having a second input receiving the signal rₖⁱ from the output 56ᵢ of filter bank 56. The outputs of the multipliers 64ᵢ and 72ᵢ are connected to the respective inputs of an adder 76ᵢ which performs the calculation of formula (2) above.

1. A reception arrangement for receiving multicarrier symbols, each multicarrier symbol (S₁, S₂, S₃) comprising a plurality of single carrier symbols, each single carrier symbol modulating a respective carrier frequency (f₁, f₂, f₃), these single carrier symbols being transmitted simultaneously, the reception arrangement comprising means for detecting the time, or phase error, of at least one single carrier and means for correcting the phase of a sampling clock in view of the estimated timing error,
wherein the means for estimating the timing or phase error comprise, at least for one carrier, means (58₁ . . . 58_{N}, 24, 40) for determining a parameter êᵢ for a carrier fᵢ, or a quantity proportional to the parameter êᵢ, according to the following formula:
$${\hat{e}}_{i} = α E ⌊ {r}_{k - 1}^{i} {a}_{k}^{i *} - {r}_{k}^{i} {a}_{k - 1}^{i *} ⌋ \qquad ( 3 )$$
wherein rₖⁱ is the detected signal for the single carrier at a time t, aₖⁱ is the corresponding single carrier symbol at the same time t, aₖ₋₁ⁱ and rₖ₋₁ⁱ correspond, respectively, to aₖⁱ and rₖⁱ at time t−NT, NT being the duration of transmission of a multicarrier symbol, and E[ ] means an average value on several successive symbols.

2. A reception arrangement according to claim 1, comprising means for calculating the parameters êᵢ for all the carriers, and means (34) for adding the values of êᵢ parameters.

3. A reception arrangement according to claim 2, comprising means (28) for assigning to each value êᵢ a weighting coefficient which depends on the quality of the transmission of the corresponding channel for the carrier.

4. A reception arrangement according to claim 3, wherein the weighting coefficient is a function of the signal to noise ratio (SNR) of the corresponding transmission channel of the single carrier.

5. A method for estimating the timing error of a received digital multicarrier signal comprising a plurality of symbols which are transmitted simultaneously at different frequencies during a given time NT, wherein the error is estimated, at least for one of the single carriers (fᵢ), according to the following formula:
$${\hat{e}}_{i} = E ⌊ {r}_{k - 1}^{i} {a}_{k}^{i *} - {r}_{k}^{i} {a}_{k - 1}^{i *} ⌋ \qquad ( 3 )$$
wherein rₖⁱ is the detected signal for the single carrier at a time t, aₖⁱ is the corresponding single carrier symbol at the same time t, aₖ₋₁ⁱ and rₖ₋₁ⁱ correspond, respectively, to aₖⁱ and rₖⁱ at time t−NT, NT being the duration of transmission of a multicarrier symbol, and E[ ] means an average value on several successive symbols.

6. A method according to claim 5, wherein the timing error is estimated by the calculation of the paramater êᵢ for all the single carriers, the multicarrier timing error signal being a weighted average of the values of said êᵢ parameters.

7. A method according to claim 6, wherein the weighting coefficient assigned to each parameter êᵢ or eᵢ is a function of the quality of transmission of the corresponding single carrier channel.

8. A method according to claim 7, wherein the weighting coefficient of each of the quantities êᵢ, or eᵢ, is a function of the signal to noise ratio of the corresponding transmission channel.
